(19) United States
(12) Patent Application Publication
(10) Pub. No.: US 2014/0087344 A1
(43) Pub. Date: Mar. 27, 2014

(54) Apparatus and Method for Demonstrating Surgical Procedures Using Dead Body Organs

(71) Applicant: Adventist Health System/Sunbelt, Inc., Altamonte Springs, FL (US)

(72) Inventor: Constantine Mavroudis, Winter Park, FL (US)

(73) Assignee: ADVENTIST HEALTH SYSTEM/SUNBELT, INC., Altamonte Springs, FL (US)

(21) Appl. No.: 14/030,087

(22) Filed: Sep. 18, 2013

Related U.S. Application Data
(60) Provisional application No. 61/704,821, filed on Sep. 24, 2012.

(51) Int. Cl. G09B 23/30

(52) U.S. Cl. CPC G09B 23/306
USPC 434/272

(57) ABSTRACT

An anatomical training apparatus secures a body organ for demonstrating and training a surgical procedure on a body organ. Tubes extend from apertures in a base to orifices in the body organ to stabilize the body organ for surgical training. Training heart surgery is further improved by extending tubes to veins and arteries to not only stabilize the heart for demonstrating surgical techniques, but for forcing fluids to flow through the heart during the training.

### CROSS-REFERENCE TO RELATED APPLICATION

This application claims the benefit of U.S. Provisional Application No. 61/704,821, having filing date of Sep. 24, 2012, the disclosure of which is hereby incorporated by reference in its entirety and commonly owned.

### FIELD OF THE INVENTION

The present invention generally relates to medical training devices and in particular to stabilizing a body organ for demonstrating a surgical procedure.

### BACKGROUND

It is desirable that an isolated organ, such as a dead heart, lung, kidney, liver, and the like be immobilized for presentation and possible dissection. By way of example, current methods of such organ immobilization typically require help from an assistant. The dead organ is typically placed in a container or nails used to attach the organ to a supporting surface. Further, it is well known to use a dead organ, such as a pig's heart, in demonstrating operation thereof by connecting conduit to ports of the hearth and pumping fluid through the heart in a controlled manner to simulate a reenactment of its operation. However, such methods and apparatus have several disadvantages, including deformation of the organ at the attachment sites, difficulty of manipulation, and undesirable instability of the immobilized organ during presentation or dissection. There is a need for a convenient positioning and stabilization of a variety of organs, thereby enabling the use of both hands when demonstrating or teaching surgical techniques on a mounted organ.

Models of body organs are well known. Most models a manufactured from a rigid plastic and may be displayed by mounting the plastic organ to a base using a peg or post. By way of example, U.S. Pat. No. 5,518,407 discloses anatomically correct artificial organ replicas for use as teaching aids. Body organs, by their very nature, are flexible and deformable and thus require more that the mounting techniques typically provided by models.

While various devices are known to aid in surgical procedures, such as described in U.S. Pat. No. 3,221,743 to Thompson for a system and apparatus for positioning and securing surgical implements; U.S. Pat. No. 5,782,746 to Wright for a local cardiac immobilization surgical device; and U.S. Pat. No. 6,936,002 to Kochamba et al. for a stabilizing tissue method and apparatus, those dedicated to teaching surgical methods typically resort to supports, such as the nailing above described.

As is well understood, surgical skills are required by a wide range of health care professionals. Simulators have provided realistic learning environments. Improvements in processors have resulted in improved simulators within health care education. However, it is appreciated by those in the art that simulation must be joined with clinical practices.

As published in the Journal of Trauma (2008 November; 65(5): 1093-4) by Ahmed et al. of the Division of Trauma and Surgical Critical care, Department of Surgery, Huron Hospital, Cleveland Clinic health System for “Multiple Organ procurement: A Tool for Teaching Operative Techniques if Major Vascular Control,” the reduction in work hours and time for operative training of residents, particularly for major vascular exposure and control, supplemental education experience id needed. Participation in multiple organ procurement (MOP) may correct this deficiency. Senior residents were given a written quiz before and after transplantation rotation and participation in MOP, for knowledge in operative exposure of great vessels of the abdomen and chest. Twenty residents, with an average of six organ retrievals per resident, showed significant improvement in surgical knowledge of vascular exposure and control after transplantation, showing that participation in MOP increases a resident's familiarity with anatomy and operative technique for expeditious exposure of the major vessels.

There remains a need for an organ holding and immobilizing apparatus for positioning, displaying and stabilizing an organ for demonstrating and teaching surgical procedures.

### SUMMARY

Embodiments of the present invention are directed to demonstrating and teaching surgical techniques on body parts, which by way of example may comprise body organs such as a heart, liver or the like, severed from an animal or human body. An apparatus according to the teachings of the present invention may a base and arms, wherein each arm includes a proximal end fixed to the base. Each arm is adapted for connecting to a portion of a body part for removably securing the body part to the base.

In one embodiment according to the teachings of the present invention, the base may comprise a plurality of apertures extending therethrough. Each arm may comprise an elongate tube. When training for surgery on a body organ, the tubes may extend from the apertures in the base to orifices in the body organ for stabilizing the body organ for the surgery. Connectors may secure ends of the tube to the base. Yet further, connectors may directly connect the base to the body part, as desired. A flow controller may be operable with the tubes for controlling fluid flow therethrough.

By way of example, the training process for training heart surgery may be further improved by extending tubes to veins and arteries to not only stabilize the heart for demonstrating surgical techniques, but for forcing fluids to flow through the heart during the training.

A method aspect of the invention may comprise teaching a surgical procedure on a body organ by providing a body part from at least one of an animal and a human. Connecting a distal end of one arm to a first portion of the body part, connecting a distal end of the second arm to a second portion of the body part, and securing proximal ends of the first and second arms to a base to stabilize the body part for performing surgery thereon.

Yet further, the arms may comprise tubes connected to orifices of the body part. Fluid may be forced through the tubes and thus the body part, such as a heart to permit a surgical procedure on the heart while fluid is passing therethrough, thus closely simulating a surgical procedure on a live body.

### BRIEF DESCRIPTION OF DRAWINGS

Embodiments of the invention are described by way of example with reference to the accompanying drawings in which:

FIG. 1 is a top plan view of one embodiment of an apparatus according to the teachings of the present invention;

FIG. 2 is a cross-sectional illustration of one embodiment of a connector illustrated in use with the apparatus of FIG. 1;

FIG. 3 is a left side perspective view of the embodiment of FIG. 1 illustrating a heart generally suspended above a base for operation thereon;

FIG. 4 is a front elevation view of the apparatus of FIG. 1 illustrating a heart secured to a base while being positioned thereon;

FIG. 5 is a perspective view of an alternate embodiment of FIG. 1 for providing support to a dead organ being secured for demonstrating a surgical procedure, by way of example;

FIGS. 5A, 5B and 5C are top plan, side elevation and end elevation views, respectively, of the cradle embodiment of FIG. 5, herein illustrated by way of example;

FIG. 6 is a perspective view of a cradle useful with the embodiment of FIGS. 1 and 5 for providing additional support to a dead organ;

FIGS. 6A, 6B and 6C are top plan, side elevation and end elevation views, respectively, of the cradle embodiment of FIG. 6, herein illustrated by way of example;

FIGS. 7 and 8 are perspective views of supporting arms of differing dimension and illustrated herein with reference to FIG. 5, by way of example;

FIGS. 7A, 7B, 7C and 8A, 8B, 8C are top plan, side elevation and front elevation views, of the supporting arms of FIGS. 7 and 8, respectively;

FIG. 9 is a perspective view of a platform attachment useful in providing an axial rotation adjustment to the supporting arms, as illustrated by way of example with reference to FIG. 5 and its related views; and

FIGS. 9A, 9B and 9C are top plan, side and end views, respectively, of the embodiments of FIG. 9.

### DETAILED DESCRIPTION OF EMBODIMENTS

The present invention will now be described more fully hereinafter with reference to the accompanying drawings, in which embodiments of the invention are shown by way of illustration and example. This invention may, however, be embodied in many forms and should not be construed as limited to the embodiments set forth herein. Rather, these embodiments are provided so that this disclosure will be thorough and complete, and will fully convey the scope of the invention to those skilled in the art. Like numerals refer to like elements.

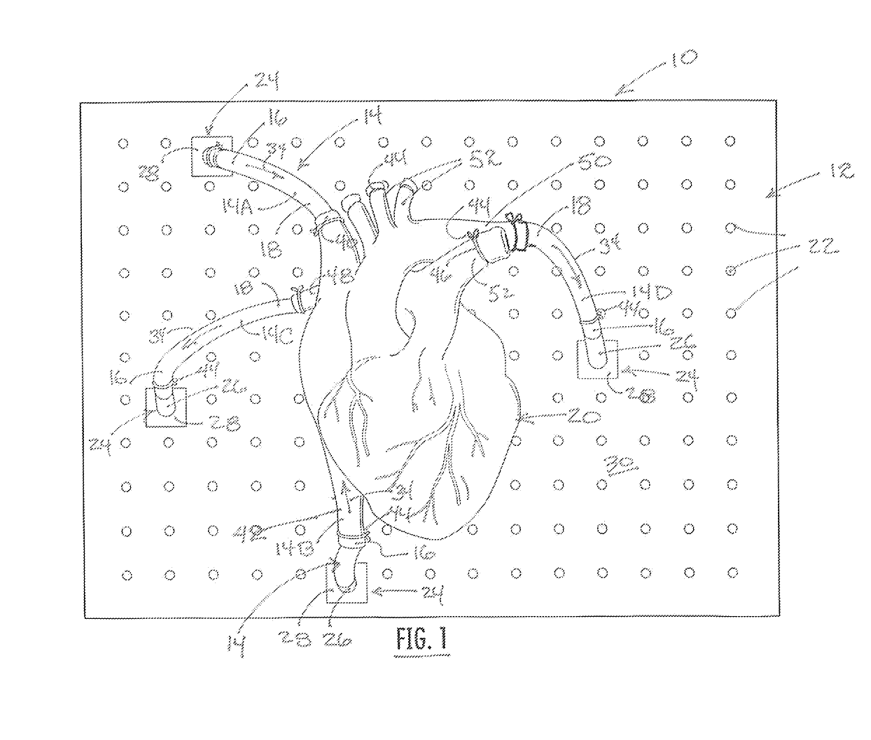

With reference initially to FIG. 1, one embodiment of the invention comprises an anatomical training apparatus 10 having a base 12 and supporting arms 14, each supporting arm herein described as having a proximal end 16 fixed to the base, and each arm moveable for connecting its distal end 18 to a body part 20, such as the dead heart herein illustrated by way of example. For the embodiment illustrated with reference to FIG. 1, the body part 20 is a human heart having been removed from a human body for teaching surgical procedures. It will be appreciated by those of skill in the art that other body parts may be used, such as a lung, or portions of body organs from human or animal bodies. As illustrated with continued reference to FIG. 1, four arms 14A, 14B, 14C, 14D are used to removably secure the heart 20 to the base 12. As herein illustrated with reference to FIG. 1, the arms 14 comprise flexible plastic tubing. Alternatively, a rigid arm structure may be employed while keeping within the teachings of the present invention, as will be described by way of example later in this disclosure.

With continued reference to FIG. 1, for the embodiment herein described by way of example, the base 12 comprises a plurality of apertures 22 extending through the base, such as in well-known pegboard material. Further for an embodiment herein described by way of example, each arm 14 includes a flexible tube portion. A connector 24 extends into the aperture 22 and the proximal end 16 of the arm 14 and is secured to the connector. The connector 24, herein described by way of example in one embodiment with reference to FIGS. 1 and 2, comprises a peg 26 extending into the aperture 22, wherein the peg is secured to a platform 28 which contacts a surface 30 of the base 12 for enhancing stability of the peg when placed into the aperture, as further illustrated with reference to FIG. 2.

With continued reference to FIGS. 1 and 2, the connector 24, herein described by way of example, comprises an orifice 32 extending through the peg 26. The combination of the tube 14 and the peg 26 having the orifice 32 permits fluid flow, illustrated using arrows 34, and a flow controller 36 to control the fluid flow 34 through the arms 14 including the flexible tubular portion and thus through the heart 20, as may be desired.

To further provide an example for use of the apparatus 10 in holding the organ 20, such as the heart, and immobilizing the heart for positioning, displaying and stabilizing it for demonstrating and teaching surgical procedures, reference is again made to FIG. 1, wherein the arm 14 includes a first arm 14A having its distal end 18 attached to a first port 40, herein the superior vena cava of the human heart 20. The arm, a second arm 14B, is attached to a second port 42 of the heart 20, herein the inferior vena cava, by way of example. The distal ends 18 extend into the orifices of the veins 40, 42 and are secured to the veins using a tie string or clamp 44, by way of example. The proximal ends 16 of the arms 14A, 14B are each connected to their respective pegs 26, and as illustrated with reference again to FIG. 2 may be secured to the pegs using the tie string or clamp 44. Optionally, the proximal and distal ends 16, 18 of the arms 14 may comprise grooves 46 to enhance the securing by the tie strings 44.

As will come to the mind of those skilled in the art, differing means of connecting the arms 14 to the base 12 and to the body part 20 may be utilized without departing from the teachings of the present invention. By way of example, the arms 14 may be dimension for being inserted directly into the apertures 22 at the arm proximal ends 16.

By way of further example, and with continued reference to FIG. 1, third and fourth arms 14C, 14D are connected as above described, but to third and fourth ports 48, 50, herein right and left pulmonary arteries. With such as arrangement, the fluid flow 34 may be controlled to have flow into the first and second arms 14A, 14B and out of the third and fourth arms 14C, 14D, thus simulating flow into the heart 20 through the veins and out through the arteries. As further illustrated with reference to FIG. 1, unused ports 52 may are preferably closed.

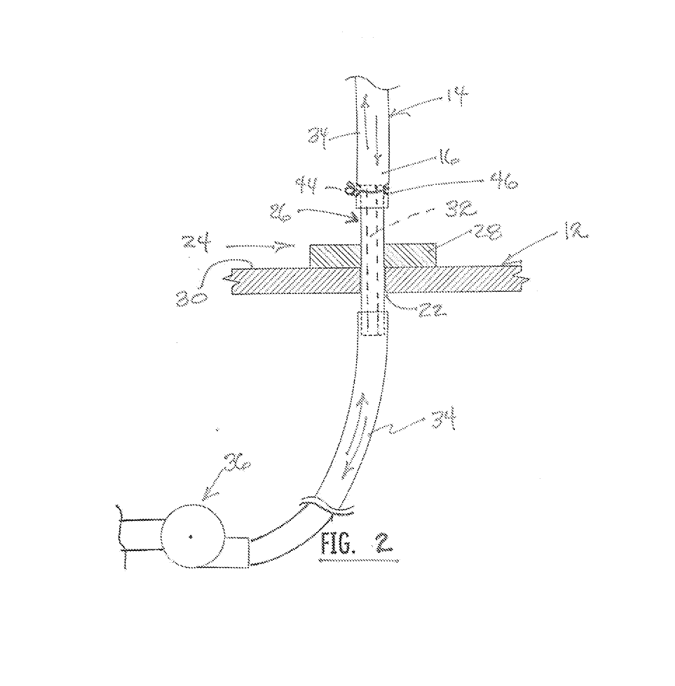

As illustrated with reference to FIGS. 3 and 4, as will come to the mind of those skilled in the art, now having the benefit of the teachings of the present invention, the body part 20 being stabilized for a surgical demonstration may be stabilized as desired, including suspending the body part in a spaced relation to the base 12, as illustrated with reference to the perspective view of FIG. 3 or having a portion thereof resting upon the base 12 in frictional contact therewith, as illustrated with reference to the elevation view of FIG. 4.

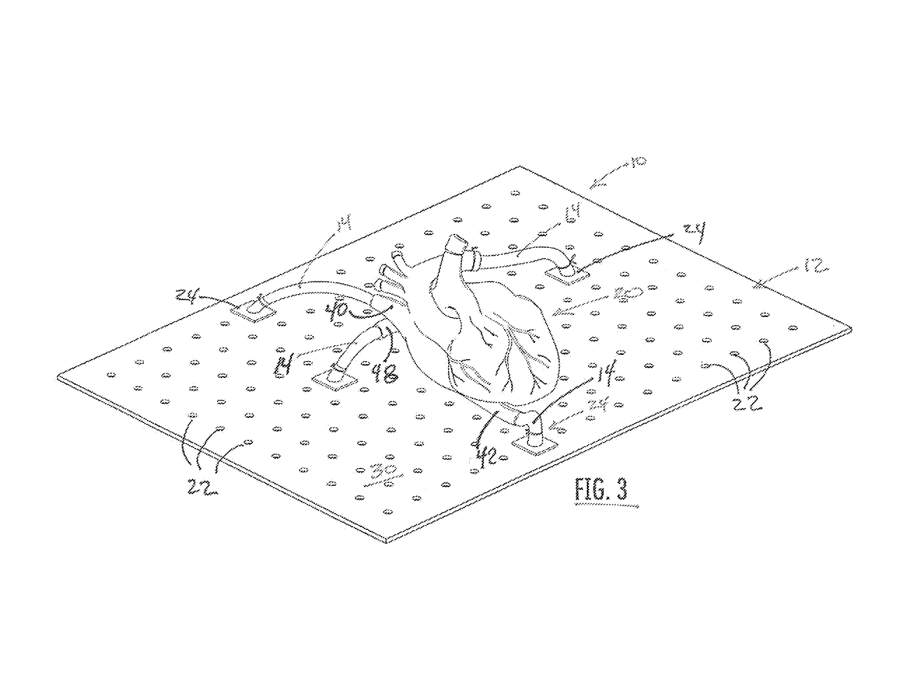

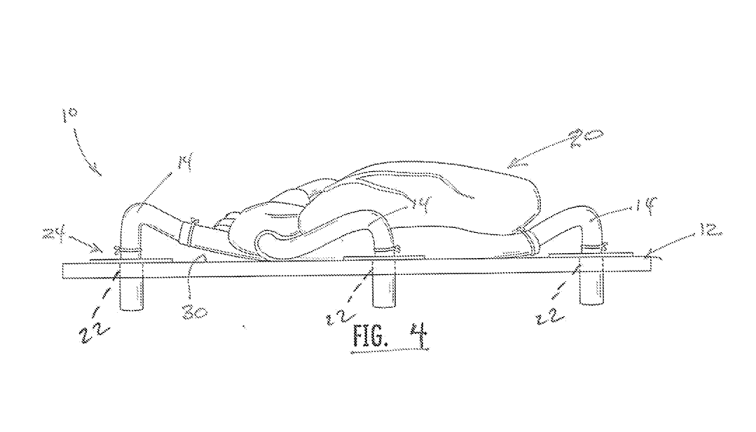

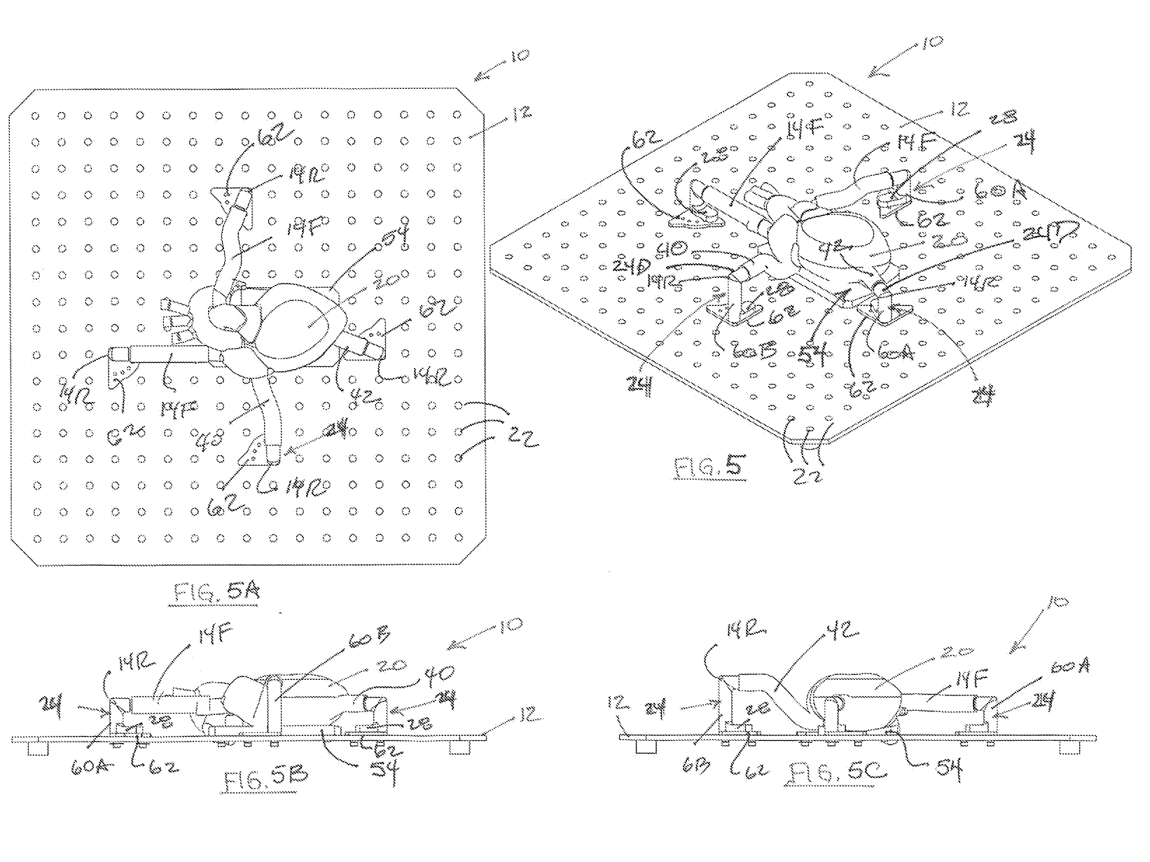

With reference now to FIG. 5, and to its related views of FIGS. 5A, 5B and 5C, and in keeping with the teachings of the present invention, an alternate embodiment of the apparatus 10 for providing support to the dead organ 20 comprises use of a cradle 54, further illustrated with reference to FIG. 6 and related views of FIGS. 6A, 6B and 6C. The cradle 54 is removably attached to the base 12 using posts 56 frictionally secured into the apertures 22 within the base 12. The supporting surface 58 for receiving the organ 20 may be contoured as desired.

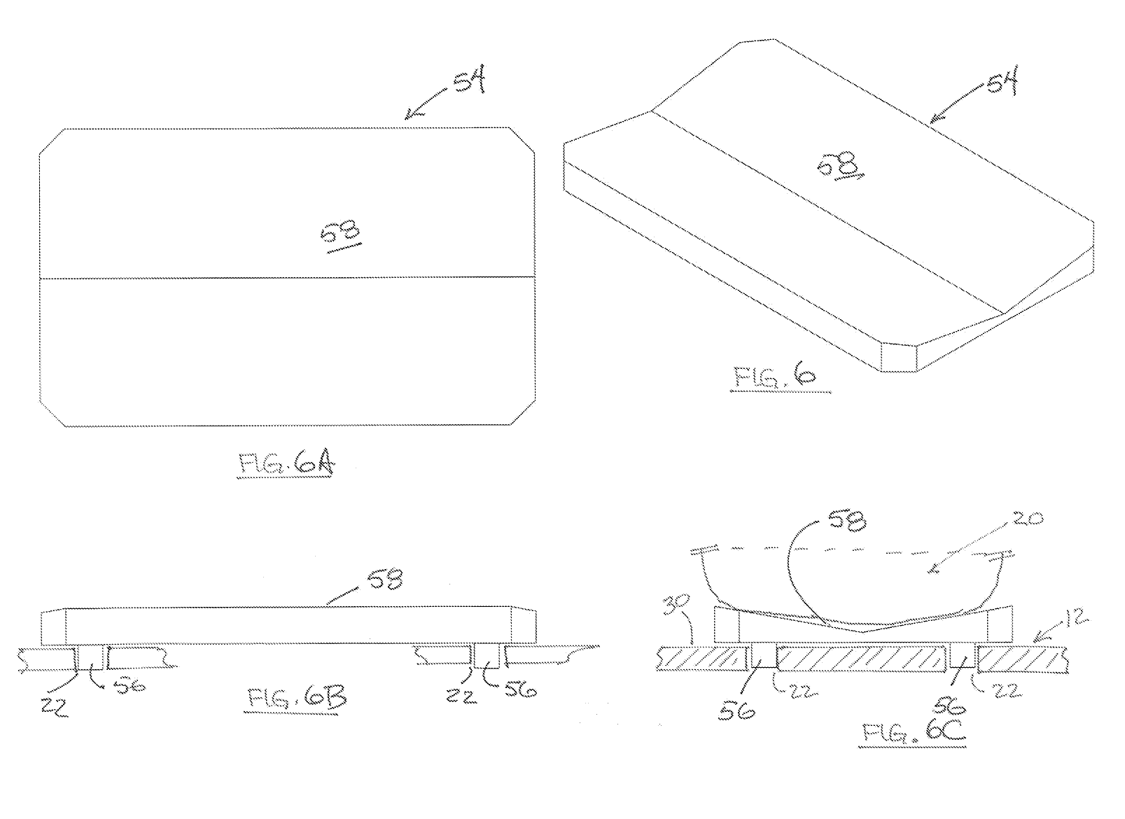

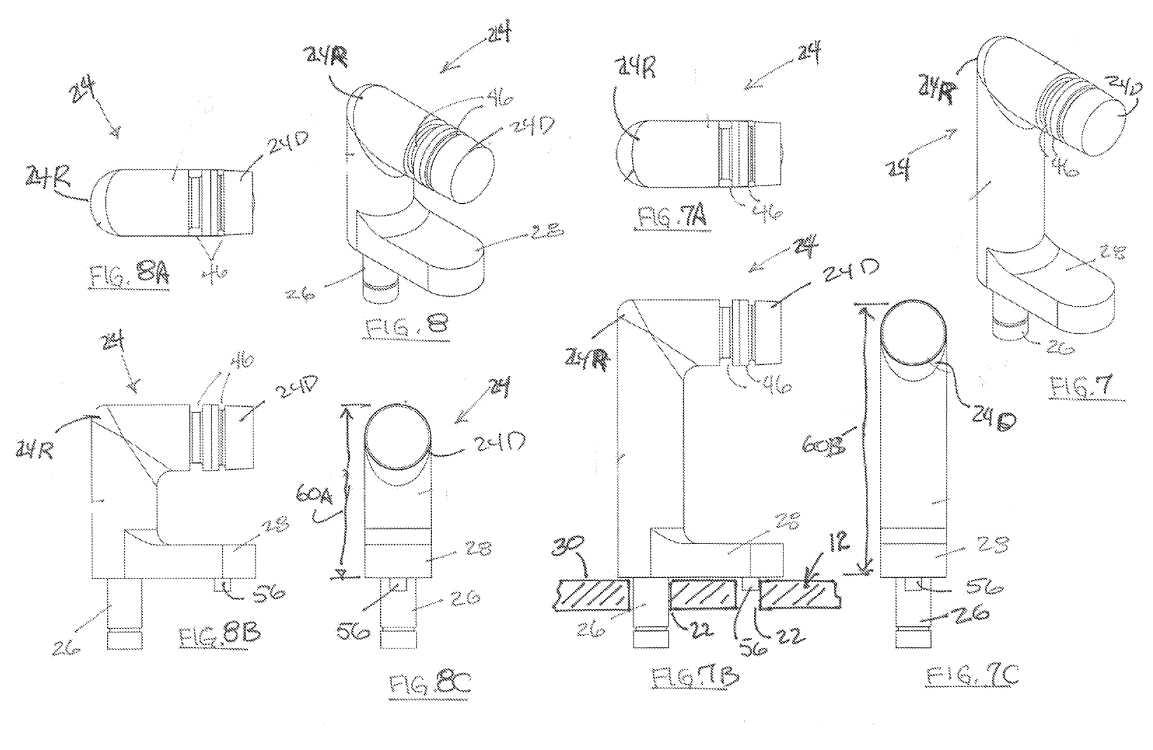

With continued reference to FIG. 5 and related views of FIGS. 5A, 5B and 5C, the connector 24 operable with the arms 14 include an angled rigid portion 24R, as illustrated with reference to FIG. 7 and its related views of FIGS. 7A, 7B and 7C. By way of example, FIGS. 7 and 8 are perspective views of the connector 24 is rigid and includes an angled portion 24R, wherein differing height dimensions 60A, 60B are illustrated, by way of example. FIGS. 8A, 8B and 8C are related views of FIG. 8. As illustrated with reference again to FIGS. 5, 5A, 5B and 5C, the organ ports 40, 42, 48, 50 may be connected directly to the connector 24 or optionally use a flexible tube portion 14F may be used. As illustrated with reference to FIGS. 7 and 8, and their related views, grooves 46 may be employed using the tie string 44 or suture earlier described with reference to FIG. 2.

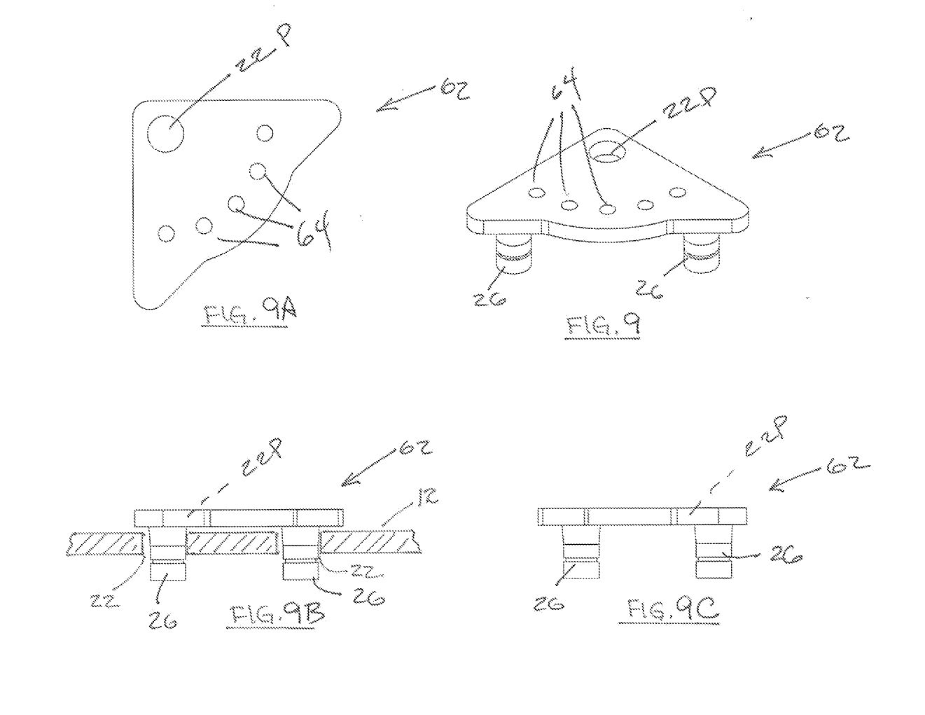

While use of a pegboard styled base 12 has proven to be practical and cost effective, especially when the apparatus may be discarded after a teaching demonstration, it may be advantageous to have an expanded incremental adjustment when positioning the connectors 24 having the structure described with reference to FIGS. 5, 7 and 8. To allow for an increased incremental rotational movement of the rigid connector 24, a rotational adjustment plate 62 may be employed, as illustrated with reference again to FIG. 5 and to FIGS. 9, 9A, 9B and 9C. Rather than the peg 26 with the connector 24 being inserted into the aperture 22 of the base 12, the plate 62 is attached to the base 12 using pegs 26 extending therefrom and frictionally inserting the pegs into the appropriate apertures 22 as may be desired. The rigid angled connector 24 is then inserted into an aperture 22P within the plate 62 and the platform 28, illustrated with reference again to FIGS. 7 and 8, is rotated to allow a post 56 extending from a bottom surface of the platform 28 to be inserted into one of a plurality of holes 64 positioned within the plate 62 to secure the arm portion 24R in a preselected rotational position as desired.

With reference again to FIG. 5, by way of example, the ports 40, 42 may be directly connected to distal ends 24D of the connector 24, as desired. As further illustrated with continued referee to FIG. 5, arms 14 may be included in the connection of the distal ends 24D to the ports 48, 50, as may be desired for securing the body organ 20 for a preselected surgical demonstration. Yet further, the arm portion 24R of the connector may be angled, as herein described by way of example, or be formed having a straight axis, as earlier illustrated with reference to FIGS. 1 and 2 without departing form the teachings of the present invention.

By way of further example with regard to teaching surgical procedures on the heart 20, multiple arms 14 will be attached to multiple organ ports 40, 42, 48, 50, which ports may be selected based on a procedure being taught. The following provides examples of various connections to stabilize various portions of the heart depending upon the selected surgical procedure.

For a surgical procedure directed to an atrial septal defect, the tubes 14 may preferably include the superior vena cava tube 14A, the inferior vena cava tube 14B, the pulmonary vein tubes 14C, 14D, as above described with reference to FIG. 1, and further an ascending aorta tube (not shown). Now having the benefit of the teachings of the invention, those of skill in the art will appreciate the benefits of stabilizing a real body part for demonstrating a surgical procedure. The heart has been presented by way of example because of its many options. However, teachings surgical procedures or simply displaying real body parts will benefit as well.

With regard to the human heart, and by way of yet further example, for a surgical procedure directed to an ventricular septal defect, the tubes to be connected may include, an inferior vena cava tube, a superior vena cava tube, an ascending aorta tube, a main pulmonary veins tubes, and a left pulmonary veins tubes. For a surgical procedure directed to a mitral valve annuloplasty, the tubes to be connected may include an inferior vena cava tube, a superior vena cava tube, an ascending aorta tube, a main pulmonary artery tube, a right pulmonary veins tubes, and a left pulmonary veins tubes. For a surgical procedure directed to a mitral valve replacement, the tubes to be connected may include an inferior vena cava tube, a superior vena cava tube, an ascending aorta tube, a main pulmonary artery tube, a right pulmonary vein tube, and a left pulmonary vein tube. For a surgical procedure directed to a tricuspid valve annuloplasty, the tubes to be connected may include an inferior vena cava tube, a superior vena cava tube, an ascending aorta tube, a main pulmonary artery tube, a right pulmonary vein tube, and a left pulmonary vein tube. For a surgical procedure directed to a tricuspid valve replacement, the tubes to be connected may include an inferior vena cava tube, a superior vena cava tube, an ascending aorta tube, a main pulmonary artery tube, a right pulmonary vein tube, and a left pulmonary vein tube. For a surgical procedure directed to a ventricular aneurysm defect, the tubes to be connected may include an inferior vena cava tube, a superior vena cava tube, an innominate artery tube, a left carotid artery tube, a main pulmonary artery tube, a right pulmonary vein tube (as desired), and a left pulmonary vein tube (as desired). For a surgical procedure directed to an aortic valve replacement defect, the tubes to be connected may include an inferior vena cava tube, a superior vena cava tube, an innominate artery tube, a left carotid artery tube, a main pulmonary artery tube, a right pulmonary vein tube (as desired), and a left pulmonary vein tube (as desired). For a pulmonary valve replacement defect, the tubes to be connected may include an inferior vena cava tube, a superior vena cava tube, an ascending aorta tube, a right pulmonary artery tube, a left pulmonary artery tube, a right pulmonary vein tube (as desired), and a left pulmonary vein tube (as desired). For a surgical procedure directed to a MAZE procedure defect, the tubes to be connected may include an inferior vena cava tube, a superior vena cava tube, an ascending aorta tube, a main pulmonary artery tube, a right pulmonary vein tube, and a left pulmonary vein tube. For a surgical procedure directed to a coronary artery bypass grafting defect, the tubes to be connected may include an inferior vena cava tube, a superior vena cava tube, an innominate artery tube, a left carotid artery tube, a main pulmonary artery tube, a right pulmonary veins tubes, and a left pulmonary vein tube. For a surgical procedure directed to an atrial switch defect, the tubes to be connected may include an inferior vena cava tube, a superior vena cava tube, an innominate artery tube, a left carotid artery tube, a right pulmonary artery tube, a left pulmonary artery tube, a right pulmonary vein tube (as desired), and a left pulmonary vein tube (as desired). For a surgical procedure directed to a systemic to pulmonary artery shunts defect, the tubes to be connected may include an inferior vena cava tube, a superior vena cava tube, an innominate artery tube, a left carotid artery tube, a right pulmonary artery tube, a left pulmonary artery tube, a right pulmonary vein tube (as desired), and a left pulmonary vein tube (as desired). For a surgical procedure directed to a ross operation defect, the tubes to be connected may include an inferior vena cava tube, a superior vena cava tube, an innominate artery tube, a left carotid artery tube, a right pulmonary artery tube, a left pulmonary artery tube, a right pulmonary vein tube (as desired), and a left pulmonary vein tube (as desired). For a surgical procedure directed to a transverse arch and descending aortic operations defect, the tubes to be connected may include an inferior vena cava tube, a superior vena cava tube, an innominate artery tube, a left carotid artery tube, a left subclavian artery tube, a descending aorta tube, a main pulmonary artery tube, a right pulmonary vein tube (as desired), and a left pulmonary vein tube (as desired).

Although the invention has been described relative to various selected embodiments herein presented by way of example, there are numerous variations and modifications that will be readily apparent to those skilled in the art in light of the above teachings. It is therefore to be understood that, within the scope of the claims hereto attached and supported by this specification, the invention may be practiced other than as specifically described.

That which is clamed is:

1. An anatomical training apparatus comprising:
a base; and
at least two arms, each arm having a proximal end fixed to the base, and each arm dimensioned for connection to a dead body part, the dead body part received from at least one of a human body and an animal body, wherein the at least two arms sufficiently secure the base to the dead body part for providing surgery thereto.

2. The apparatus according to claim 1, wherein the base comprises a plurality of apertures extending therein.

3. The apparatus according to claim 2, wherein each arm proximal end is affixed to one aperture of the plurality of apertures within the base.

4. The apparatus according to claim 1, wherein each of the at least two arms comprises a flexible tube portion.

5. The apparatus according to claim 4, wherein the each of the at least two arms comprises a connector portion securing the proximal end of the arm to the base.

6. The apparatus according to claim 5, wherein the connector portion is comprises an orifice extending therethrough.

7. The apparatus according to claim 6, further comprising a flow controller operable with the connector for controlling a fluid flow through the elongate tube.

8. The apparatus according to claim 1, further comprising a dead body part, wherein the dead body part is at least one of an animal body organ and a human body organ, and wherein the dead body part is preselected for anatomical study.

9. The apparatus according to claim 8, wherein the dead body organ comprises a heart.

10. The apparatus according to claim 8, wherein the at least two arms comprise:
a first arm having the distal end thereof removably attached to a first port of the dead body organ; and
a second arm attached to a second port of the dead body organ.

11. The apparatus according to claim 10, wherein each of the distal ends extends into an orifice of each port.

12. The apparatus according to claim 11, wherein the first and second ports comprise a superior vena cava and an inferior vena cava, and wherein a fastener secures each vena cava to the distal end of each arm.

13. The apparatus according to claim 8, wherein the dead body part comprises a human heart, and wherein the at least two arms comprise:
a first arm having the distal end thereof attached to a superior vena cava;
a second arm having the distal end thereof attached to an inferior vena cava; and
a third arm having the distal end thereof attached to a first pulmonary artery.

14. The apparatus according to claim 13, further comprising a fourth arm having the distal end thereof attached to a second pulmonary artery, wherein the first and second pulmonary arteries comprise left and right pulmonary arteries.

15. The apparatus according to claim 14, wherein the arms are tubular for providing fluid flow into the first and second arms and out of the third and fourth arms.

16. A method of demonstrating a surgical procedure on a dead body organ, the method comprising:
providing a dead body part from at least one of an animal and a human;
providing first and second arms;
connecting a distal end of the first arm to a first portion of the dead body part;
connecting a distal end of the second arm to a second portion of the dead body part; and
securing proximal ends of the first and second arms to a base, wherein the securing sufficiently stabilizes the dead body part for performing surgery thereon.

17. The method according to claim 16, wherein the first and second arms providing step comprises providing first and second tubes.

18. The method according to claim 17, wherein the connecting steps comprises extending the tube distal ends into orifices of the body part.

19. The method according to claim 18, wherein the base comprises apertures extending therethrough, and wherein the tube proximal ends are operable therewith for passing fluid therethrough.

20. The method according to claim 19, wherein the proximal end securing step comprises extending a connector into a selected aperture and connecting the tube proximal end to the connector.

21. The method according to claim 16, wherein providing the dead body part comprises providing a human heart, and wherein the distal end connecting steps comprise connecting the distal ends to first and second veins.

22. The method according to claim 21, further comprising connecting the distal end of a third arm to an artery.

23. The method according to claim 22, wherein the distal end connecting steps comprise connecting the first and second arms to a superior vena cava and an inferior vena cava, and connecting the third arm to a first pulmonary artery.

24. The method according to claim 23, further comprising connecting a fourth arm to a second pulmonary artery, wherein the first and second pulmonary arteries comprise left and right pulmonary arteries.

25. The method according to claim 24, wherein the arms including a lumen extending therethrough, and wherein the method further comprises forcing a fluid to flow through the first and second arms into the heart and out of the third and fourth arms.

26. The method according to claim 16, wherein the first and second arms providing step comprises providing first and second connectors.

27. The method according to claim 26, wherein the connecting steps comprises extending connector distal ends into orifices of the body part.

28. The method according to claim 27, wherein the base comprises apertures extending therethrough, and wherein the connector proximal ends are attached thereto.
